(19) United States
(12) Patent Application Publication
(10) Pub. No.: US 2026/0166666 A1
(43) Pub. Date: Jun. 18, 2026

(54) SUPPORT JIG AND SUPPORT METHOD FOR CUTTING TOOL

(71) Applicant: IHI Corporation, Tokyo (JP)

(72) Inventors: Hiroo KAKUTA, Tokyo (JP); Yu HORIUCHI, Tokyo (JP); Nobutaka YANAGIDANI, Tokyo (JP); Yusuke ARAMAKI, Tokyo (JP); Yasuhiro ISHIKURO, Tokyo (JP); Akiyuki NISHITANI, Tokyo (JP); Yuichi MIURA, Tokyo (JP)

(73) Assignee: IHI Corporation, Tokyo (JP)

(21) Appl. No.: 19/533,565

(22) Filed: Feb. 9, 2026

Related U.S. Application Data
(63) Continuation of application No. PCT/JP2025/007734, filed on Mar. 4, 2025.

(30) Foreign Application Priority Data
Mar. 21, 2024 (JP) 2024-044701

(51) Int. Cl. B23Q 1/25

(52) U.S. Cl. CPC B23Q 1/25

(57) ABSTRACT

A support jig and support method for a cutting tool that expands a hole diameter penetrating from a first surface to a second surface of a cylindrical member. The cutting tool has a cutting portion that inserts into the hole from the first surface side to cut the inner surface, and a pilot provided on the rotation axis at the cutting portion tip. The support jig includes a first base, a guide, and a second base. The first base abuts the first surface and aligns a straight line perpendicular to the first surface at the hole position with the cutting portion rotation axis. The guide has an insertion hole for the pilot and is disposed on the second surface side. The second base supports the guide allowing the insertion hole central axis to swing, and brings the guide into contact with the hole opening.

### CROSS REFERENCE TO RELATED APPLICATIONS

This application is a continuation application of International Application No. PCT/JP 2025/007734, filed on Mar. 4, 2025, which claims priority to Japanese Patent Application No. 2024-044701, filed on Mar. 21, 2024, the entire contents of which are incorporated by reference herein.

### TECHNICAL FIELD

The present disclosure relates to a support jig and support method for a cutting tool.

### BACKGROUND ART

Patent Literature 1 (Japanese Patent Application Laid-Open No. 2010-12532) discloses an end mill (cutting tool) that does not leave cutting marks on a machined surface when machining a material that produces radial cutting marks during cutting. A guide portion is formed at the tip of the end mill for fitting into a guide hole formed in a workpiece to be cut, and when the end mill cuts a spot-faced surface of the workpiece, the guide portion fits into the guide hole.

### SUMMARY OF THE INVENTION

### Technical Problem

When the technology described in Patent Literature 1 is used for expanding the diameter of a hole penetrating in the radial direction of a cylindrical member, it is necessary to hold the cylindrical member while maintaining roundness and to position the rotation axis of the cutting portion of the cutting tool toward the central axis of the cylindrical member in order to improve the accuracy of diameter expansion. Therefore, there is a problem that costs and labor are likely to increase when accurately performing diameter expansion of the hole.

The present disclosure has been made in view of the above problem. The object thereof is to provide a support jig and support method for a cutting tool capable of suppressing costs and labor when accurately performing diameter expansion of a hole penetrating in the radial direction of a cylindrical member.

### Solution to Problem

A support jig for a cutting tool according to the present disclosure supports a cutting tool that expands the diameter of a hole penetrating from a first surface to a second surface of a cylindrical member. The cutting tool includes a cutting portion and a pilot. The cutting portion is inserted into the hole from the first surface side to cut the inner surface of the hole. The pilot is provided on the rotation axis of the cutting portion at the tip of the cutting portion with reference to the insertion direction of the cutting portion into the hole. The support jig includes a first base, a guide, and a second base. The first base abuts against the first surface and aligns a straight line perpendicular to the first surface at the position of the hole with the rotation axis of the cutting portion. The guide is provided with an insertion hole into which the pilot is inserted and is disposed on the second surface side. The second base supports the guide in a state where the central axis of the insertion hole can swing, and brings the guide into contact with the opening of the hole.

The first base may abut at least at different first, second, and third contact points on the first surface. For the first contact point and the second contact point, the distances to the straight line when projected onto a plane perpendicular to the central axis of the cylindrical member may be equal. Along the central axis of the cylindrical member, the position of the third contact point may differ from the positions of the first contact point and the second contact point.

The second base may position an intersection point where the straight line and the central axis of the insertion hole intersect with respect to the hole.

The guide may be constituted by a spherical bearing, the central axis of the insertion hole may pass through the center of the spherical surface of the spherical bearing, and the spherical surface may abut against the opening.

The inner diameter of the insertion hole may be smaller than the inner diameter of the hole.

The support jig may further include a moving portion provided on the first base that moves the cutting portion so that the cutting portion cuts a range of the inner surface from the first surface to a predetermined depth.

The predetermined depth may be shorter than the length of the hole from the first surface to the second surface.

The material on the first surface side of the cylindrical member and the material on the second surface side may be different.

The material on the second surface side of the cylindrical member may be a composite material.

The material on the first surface side of the cylindrical member may be aluminum or an aluminum alloy.

The outer circumferential surface of the cylindrical member may be the first surface, and the inner circumferential surface of the cylindrical member may be the second surface.

A support method for a cutting tool according to the present disclosure disposes a cylindrical member between a first base and a second base, brings the first base into contact with the first surface and brings a guide into contact with the second surface, and inserts the cutting portion into the hole with the pilot inserted in the insertion hole.

### Advantageous Effects of Invention

According to the present disclosure, it is possible to provide a support jig and support method for a cutting tool capable of suppressing costs and labor when accurately performing diameter expansion of a hole penetrating in the radial direction of a cylindrical member.

### BRIEF DESCRIPTION OF DRAWINGS

FIG. 1 is a side view of a support jig for a cutting tool according to an embodiment of the present disclosure.

FIG. 2 is a cross-sectional view of a support jig for a cutting tool according to an embodiment of the present disclosure.

FIG. 3 is a flowchart of a support method for a cutting tool according to an embodiment of the present disclosure.

### DESCRIPTION OF EMBODIMENTS

Hereinafter, some exemplary embodiments will be described with reference to the drawings. In the drawings, common parts are denoted by the same reference numerals, and redundant description is omitted.

### Configuration of Support Jig

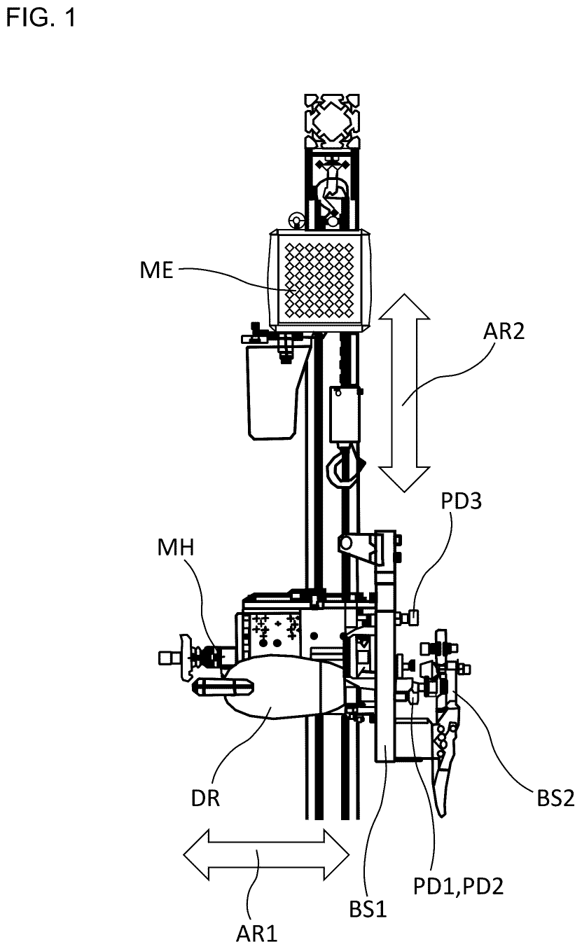

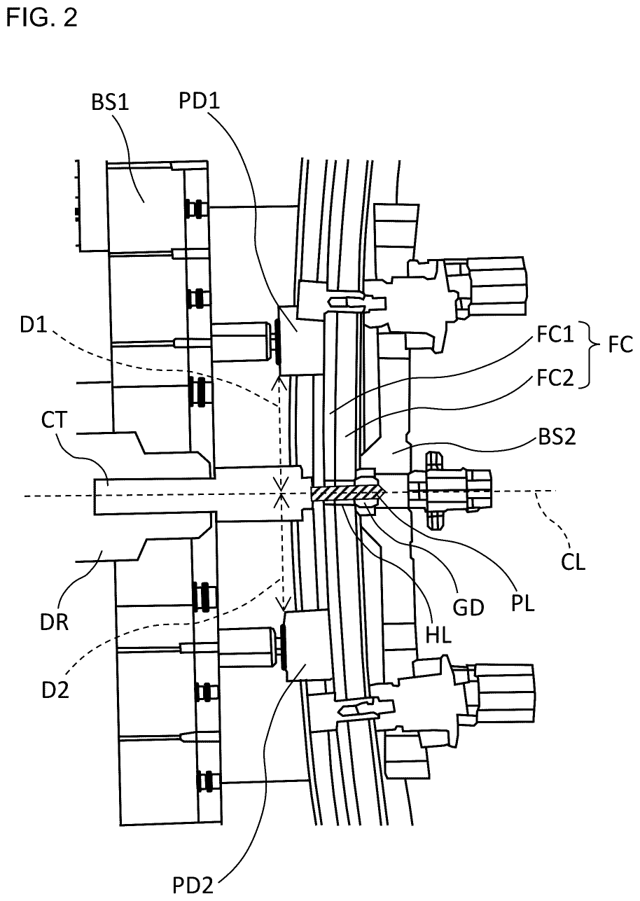

FIG. 1 is a side view of a support jig for a cutting tool according to an embodiment of the present disclosure. FIG. 2 is a cross-sectional view of a support jig for a cutting tool according to an embodiment of the present disclosure. FIG. 1 shows a side view of the cutting tool DR and the support jig as viewed from a horizontal direction. FIG. 2 shows a cross-section on a plane perpendicular to the central axis of the cylindrical member FC with respect to a state in which the support jig is installed on the cylindrical member FC.

The cutting tool DR expands the diameter of a hole HL penetrating from the first surface to the second surface of the cylindrical member FC. For example, the “first surface” is the outer circumferential surface of the cylindrical member FC, and the “second surface” is the inner circumferential surface of the cylindrical member FC. Conversely, the “first surface” may be the inner circumferential surface of the cylindrical member FC, and the “second surface” may be the outer circumferential surface of the cylindrical member FC. The first surface of the cylindrical member FC is one of the outer circumferential surface and the inner circumferential surface, and the second surface is the other of the outer circumferential surface and the inner circumferential surface.

Here, in the cylindrical member FC to be machined by the cutting tool DR, the material on the first surface side and the material on the second surface side may be different. For example, the cylindrical member FC may be constituted by an outer circumferential surface material FC1 and an inner circumferential surface material FC2.

For example, the material on the second surface side of the cylindrical member FC may be a composite material. The material on the first surface side of the cylindrical member FC may be aluminum or an aluminum alloy. The configuration of the cylindrical member FC is not limited to the examples given here.

The problem when attempting to expand the diameter of the hole HL penetrating in the radial direction (direction perpendicular to the first surface and the second surface) of the cylindrical member FC with the cutting tool DR without using the support jig according to the embodiment of the present disclosure will be explained. For example, when attempting to expand the diameter of the hole HL accurately with the cutting tool DR, it is necessary to hold the cylindrical member FC while maintaining the roundness of the cylindrical member FC. More specifically, it is necessary to load the cylindrical member FC on a machining center or the like and confirm the reference surface with a probe or the like.

Then, after confirming that the hole HL is directed toward the central axis of the cylindrical member FC, it is necessary to perform machining with the cutting tool DR. When the size of the cylindrical member FC is larger than the cutting tool DR, it becomes necessary to prepare a machining center matched to the size of the cylindrical member FC. As a result, costs and labor increase in order to hold the cylindrical member FC while maintaining the roundness of the cylindrical member FC.

Furthermore, since there is no mark for identifying the central axis of the cylindrical member FC, it is difficult to make the rotation axis of the cutting portion CT of the cutting tool DR perpendicular to the central axis of the cylindrical member FC. Although a method of determining the perpendicular direction using the hole HL is also conceivable, when the inner surface of the hole HL has irregularities due to corrosion or the like, there is also a problem that the direction cannot be accurately determined.

The support jig according to the embodiment of the present disclosure solves the above-described problems. For example, it is possible to eliminate the need for a machining center for holding the cylindrical member FC while maintaining the roundness of the cylindrical member FC. Furthermore, it becomes possible to suppress costs and labor when accurately performing diameter expansion of the hole HL penetrating in the radial direction of the cylindrical member FC.

The cutting tool DR includes a cutting portion CT and a pilot PL. The cutting portion CT is inserted into the hole HL from the first surface side to cut the inner surface of the hole HL. For example, the cutting portion CT receives driving force from a motor provided in the cutting tool DR and rotates around a predetermined rotation axis. Then, a blade provided on the outer circumferential surface of the cutting portion CT cuts the inner surface of the hole HL.

The pilot PL is provided on the rotation axis of the cutting portion CT at the tip of the cutting portion CT with reference to the insertion direction of the cutting portion CT into the hole HL. The pilot PL is constituted in a cylindrical shape, and the outer diameter of the pilot PL may be smaller than the inner diameter of the hole HL. This allows the cutting portion CT provided with the pilot PL to be inserted into the hole HL. In consideration of the case where the inner surface of the hole HL has irregularities due to corrosion or the like, the outer diameter of the pilot PL may be set to a size obtained by subtracting a length approximately equal to the size of the irregularities from the inner diameter of the hole HL.

The support jig includes a first base BS1, a guide GD, and a second base BS2. The cutting tool DR is supported by the first base BS1. When installing the support jig on the cylindrical member FC, the first base BS1 is disposed on the first surface side of the cylindrical member FC, and the second base BS2 and the guide GD are disposed on the second surface side of the cylindrical member FC. Then, the cylindrical member FC is sandwiched between the first base BS1 and the second base BS2.

The support jig may be configured to be capable of moving the cutting tool DR in each of directions AR1 and AR2. Here, direction AR1 is a direction along a straight line CL perpendicular to the first surface at the position of the hole HL. Direction AR2 is a direction perpendicular to direction AR1. Direction AR2 may be the gravitational direction.

For example, the support jig may include a moving portion MH provided on the first base BS1. The moving portion MH may be configured to be capable of moving the cutting tool DR along the straight line CL perpendicular to the first surface at the position of the hole HL. The moving portion MH may be a manual linear motion unit.

The moving portion MH may move the cutting portion CT so that the cutting portion CT cuts a range of the inner surface of the hole HL from the first surface to a predetermined depth. The predetermined depth may be shorter than the thickness of the cylindrical member FC, that is, the length of the hole HL from the first surface to the second surface.

In addition, the support jig may include a balancer ME that suspends the first base BS1. The balancer ME may be configured to be capable of moving the cutting tool DR in the direction AR2. The balancer ME may be an electric balancer. By suspending the first base BS1 that holds the cutting tool DR with the balancer ME, the user of the cutting tool DR no longer needs to support the weight of the cutting tool DR. As a result, the efficiency of work using the cutting tool DR is improved.

The first base BS1 abuts against the first surface and aligns the straight line CL perpendicular to the first surface at the position of the hole HL with the rotation axis of the cutting portion CT.

For example, the first base BS1 may abut at least at different first, second, and third contact points on the first surface. In FIGS. 1 and 2, explanation will be given assuming that the contact portions PD1, PD2, and PD3 provided in the first base BS1 abut against the first surface at the first contact point, second contact point, and third contact point, respectively.

For the first contact point and the second contact point, the distances to the straight line CL when projected onto a plane perpendicular to the central axis of the cylindrical member FC may be equal. For example, as shown in FIG. 2, the distance D1 between the contact portion PD1 and the straight line CL and the distance D2 between the contact portion PD2 and the straight line CL may be set equal. This ensures that the first base BS1 is perpendicular to the straight line CL perpendicular to the first surface at the position of the hole HL within a plane perpendicular to the central axis of the cylindrical member FC.

Furthermore, along the central axis of the cylindrical member FC, the position of the third contact point may differ from the positions of the first contact point and the second contact point. For example, as shown in FIG. 1, along the central axis of the cylindrical member FC, the position of the contact portion PD3 may differ from the positions of the contact portions PD1 and PD2. This fixes the inclination of the first base BS1 with respect to the central axis of the cylindrical member FC.

Therefore, by the first base BS1 abutting at least at different first, second, and third contact points on the first surface, the straight line CL perpendicular to the first surface at the position of the hole HL can be aligned with the rotation axis of the cutting portion CT.

The guide GD is provided with an insertion hole into which the pilot PL is inserted and is disposed on the second surface side. For example, the guide GD may be constituted by a spherical bearing, and may be configured such that the central axis of the hole HL passes through the center of the spherical surface of the spherical bearing, and the spherical surface of the spherical bearing abuts against the opening of the hole HL.

With the spherical surface of the spherical bearing abutting against the opening of the hole HL and the pilot PL inserted into the insertion hole of the guide GD, an intersection point where the straight line CL and the central axis of the insertion hole of the guide GD intersect can be positioned with respect to the hole HL. As a result, the rotation axis of the cutting portion CT of the cutting tool DR can be positioned so as to pass through the center of the opening on the second surface side of the cylindrical member FC. It also becomes possible to reduce friction occurring on the second surface side of the inner surface of the hole HL when the inner surface of the hole HL is cut by the cutting portion CT.

The inner diameter of the insertion hole provided in the guide GD may be smaller than the inner diameter of the hole HL. The inner diameter of the insertion hole may match or be approximately the same as the outer diameter of the pilot PL so that the pilot PL can be inserted into the insertion hole provided in the guide GD.

The second base BS2 supports the guide GD in a state where the central axis of the insertion hole provided in the guide GD can swing, and brings the guide GD into contact with the opening of the hole HL. The second base BS2 positions an intersection point where the straight line CL and the central axis of the insertion hole of the guide GD intersect with respect to the hole HL.

### Procedure of Support Method

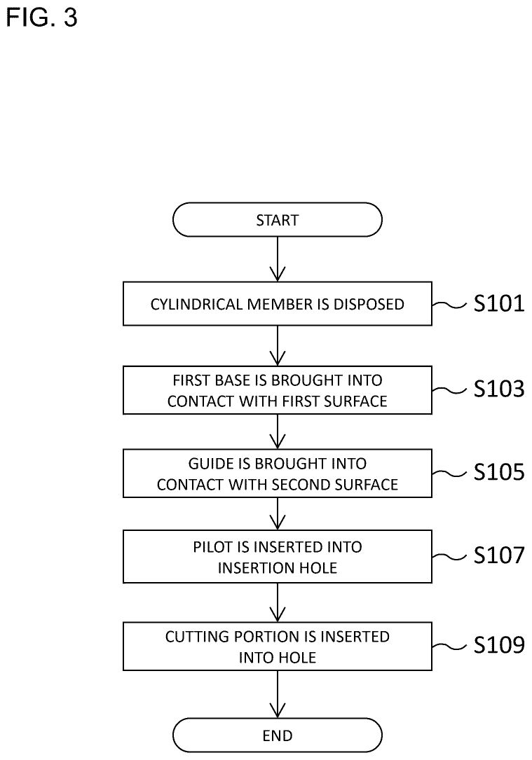

FIG. 3 is a flowchart of a support method for a cutting tool according to an embodiment of the present disclosure.

In step S101, the cylindrical member FC is disposed between the first base BS1 and the second base BS2.

In step S103, the first base BS1 is brought into contact with the first surface of the cylindrical member FC.

In step S105, the guide GD is brought into contact with the second surface of the cylindrical member FC. At that time, the second base BS2 supports the guide GD in a state where the central axis of the insertion hole provided in the guide GD can swing, and brings the guide GD into contact with the opening of the hole HL. Note that steps S103 and S105 may be performed in any order. Unlike the flowchart shown in FIG. 3, step S103 may be performed after step S105 is performed.

In step S107, the pilot PL is inserted into the insertion hole of the guide GD.

In step S109, with the pilot PL inserted in the insertion hole of the guide GD, the cutting portion CT is inserted into the hole HL. Thereafter, the inner surface of the hole HL is cut by the cutting portion CT to expand the diameter of the hole HL.

### Effects of Embodiment

As described in detail above, a support jig for a cutting tool according to the present disclosure supports a cutting tool that expands the diameter of a hole penetrating from a first surface to a second surface of a cylindrical member. The cutting tool includes a cutting portion and a pilot. The cutting portion is inserted into the hole from the first surface side to cut the inner surface of the hole. The pilot is provided on the rotation axis of the cutting portion at the tip of the cutting portion with reference to the insertion direction of the cutting portion into the hole. The support jig includes a first base, a guide, and a second base. The first base abuts against the first surface and aligns a straight line perpendicular to the first surface at the position of the hole with the rotation axis of the cutting portion. The guide is provided with an insertion hole into which the pilot is inserted and is disposed on the second surface side. The second base supports the guide in a state where the central axis of the insertion hole can swing, and brings the guide into contact with the opening of the hole.

This makes it possible to suppress costs and labor when accurately performing diameter expansion of a hole penetrating in the radial direction of a cylindrical member. For example, it is possible to eliminate the need for a machining center for holding the cylindrical member FC while maintaining the roundness of the cylindrical member FC. The orientation of the cutting tool can be set according to the direction of the hole without maintaining the roundness of the cylindrical member FC, and diameter expansion of the hole can be accurately performed while suppressing costs and labor.

The first base may abut at least at different first, second, and third contact points on the first surface. For the first contact point and the second contact point, the distances to the straight line when projected onto a plane perpendicular to the central axis of the cylindrical member may be equal. Along the central axis of the cylindrical member, the position of the third contact point may differ from the positions of the first contact point and the second contact point. This makes it possible to align the straight line perpendicular to the first surface at the position of the hole with the rotation axis of the cutting portion. As a result, diameter expansion of the hole can be accurately performed.

The second base may position an intersection point where the straight line and the central axis of the insertion hole intersect with respect to the hole. This prevents the pilot and the cutting portion from damaging the inner surface of the hole on the second surface side. As a result, machining of the inner surface of the hole with consideration for the material on the second surface side can be realized. Furthermore, it also becomes possible to reduce friction occurring on the second surface side of the inner surface of the hole.

The guide may be constituted by a spherical bearing, the central axis of the insertion hole may pass through the center of the spherical surface of the spherical bearing, and the spherical surface may abut against the opening. This makes it possible to position an intersection point where the straight line perpendicular to the first surface at the position of the hole and the central axis of the insertion hole of the guide intersect with respect to the hole. As a result, the rotation axis of the cutting portion of the cutting tool can be positioned so as to pass through the center of the opening on the second surface side of the cylindrical member.

The inner diameter of the insertion hole may be smaller than the inner diameter of the hole. This allows the pilot inserted into the insertion hole to pass through the hole. As a result, the pilot is prevented from damaging the inner surface of the hole.

The support jig may further include a moving portion provided on the first base that moves the cutting portion so that the cutting portion cuts a range of the inner surface from the first surface to a predetermined depth. This improves the efficiency of work using the cutting tool.

The predetermined depth may be shorter than the length of the hole from the first surface to the second surface. This prevents the pilot and the cutting portion from damaging the inner surface of the hole on the second surface side. As a result, machining of the inner surface of the hole with consideration for the material on the second surface side can be realized.

The material on the first surface side of the cylindrical member and the material on the second surface side may be different. The material on the second surface side of the cylindrical member may be a composite material. The material on the first surface side of the cylindrical member may be aluminum or an aluminum alloy. These allow the support jig to hold the cutting tool DR that machines a cylindrical member composed of two or more types of materials.

The outer circumferential surface of the cylindrical member may be the first surface, and the inner circumferential surface of the cylindrical member may be the second surface. This allows diameter expansion of the hole to be performed from the outer circumferential surface of the cylindrical member with the cutting tool.

A support method for a cutting tool according to the present disclosure disposes a cylindrical member between a first base and a second base, brings the first base into contact with the first surface and brings a guide into contact with the second surface, and inserts the cutting portion into the hole with the pilot inserted in the insertion hole. This makes it possible to suppress costs and labor when accurately performing diameter expansion of a hole penetrating in the radial direction of a cylindrical member.

According to the present disclosure, costs and labor when accurately performing diameter expansion of a hole penetrating in the radial direction of a cylindrical member can be suppressed, and work efficiency can be improved. Therefore, for example, it is possible to contribute to Goal 8 of the Sustainable Development Goals (SDGs) promoted by the United Nations: “Promote sustained, inclusive and sustainable economic growth, full and productive employment and decent work for all.”

Although some embodiments have been described, modifications or variations of the embodiments are possible based on the above disclosure. All the constituent elements of the above embodiments and all the features described in the claims may be individually extracted and combined as long as they do not contradict each other.

### REFERENCE SIGNS LIST

AR1, AR2 direction
BS1 first base
BS2 second base
CL straight line
CT cutting portion
D1, D2 distance
DR cutting tool
FC1 outer circumferential surface material
FC2 inner circumferential surface material
FC cylindrical member
GD guide
HL hole
ME balancer
MH moving portion
PD1, PD2, PD3 contact portion
PL pilot

1. A support jig for a cutting tool that expands a diameter of a hole penetrating from a first surface to a second surface of a cylindrical member, wherein
the cutting tool comprises:
a cutting portion that is inserted into the hole from the first surface side to cut an inner surface of the hole; and
a pilot provided on a rotation axis of the cutting portion at a tip of the cutting portion with reference to an insertion direction of the cutting portion into the hole;
the support jig comprises:
a first base that abuts against the first surface and aligns a straight line perpendicular to the first surface at a position of the hole with the rotation axis of the cutting portion;
a guide provided with an insertion hole into which the pilot is inserted, the guide being disposed on the second surface side; and
a second base that supports the guide in a state where a central axis of the insertion hole can swing, and brings the guide into contact with an opening of the hole.

2. The support jig according to claim 1, wherein
the first base abuts at least at different first, second, and third contact points on the first surface,
for the first contact point and the second contact point, distances to the straight line when projected onto a plane perpendicular to a central axis of the cylindrical member are equal, and
along the central axis of the cylindrical member, a position of the third contact point differs from positions of the first contact point and the second contact point.

3. The support jig according to claim 1, wherein the second base positions an intersection point where the straight line and the central axis of the insertion hole intersect with respect to the hole.

4. The support jig according to claim 1, wherein the guide is constituted by a spherical bearing, the central axis of the insertion hole passes through a center of a spherical surface of the spherical bearing, and the spherical surface abuts against the opening.

5. The support jig according to claim 1, wherein an inner diameter of the insertion hole is smaller than an inner diameter of the hole.

6. The support jig according to claim 1, further comprising:
a moving portion provided on the first base that moves the cutting portion so that the cutting portion cuts a range of the inner surface from the first surface to a predetermined depth.

7. The support jig according to claim 6, wherein the predetermined depth is shorter than a length of the hole from the first surface to the second surface.

8. The support jig according to claim 1, wherein a material on the first surface side of the cylindrical member and a material on the second surface side are different.

9. The support jig according to claim 8, wherein the material on the second surface side of the cylindrical member is a composite material.

10. The support jig according to claim 8, wherein the material on the first surface side of the cylindrical member is aluminum or an aluminum alloy.

11. The support jig according to claim 1, wherein an outer circumferential surface of the cylindrical member is the first surface, and an inner circumferential surface of the cylindrical member is the second surface.

12. A support method for the cutting tool using the support jig according to claim 1, the method comprising:
disposing the cylindrical member between the first base and the second base;
bringing the first base into contact with the first surface and bringing the guide into contact with the second surface; and
inserting the cutting portion into the hole with the pilot inserted in the insertion hole.
